(19) United States
(12) Patent Application Publication
(10) Pub. No.: US 2006/0125315 A1
(43) Pub. Date: Jun. 15, 2006

(54) Passive pre-charge system for a vehicular brake system

(76) Inventor: Patrick H. Hool, St. Clair, MI (US)

Correspondence Address: MACMILLAN, SOBANSKI & TODD, LLC, ONE MARITIME PLAZA - FOURTH FLOOR, 720 WATER STREET, TOLEDO, OH, 43604, US

(21) Appl. No.: 11/013,182

(22) Filed: Dec. 15, 2004

(51) Int. Cl. B60T 8/40

(52) U.S. Cl. 303/116.2

(57) ABSTRACT

An electronically controlled vehicular hydraulic brake system provides anti-lock braking, traction control, and/or vehicle stability control. The system includes a hydraulic control unit (HCU) containing pumps, valves, and other components in fluid communication with wheel brakes. Performance of the braking system can be improved by systems and methods according to this invention. A preferred system for improving braking performance according to the present invention includes a passive precharge system having a precharge manifold.

### BACKGROUND OF THE INVENTION

This invention relates in general to vehicular hydraulic brake systems and in particular is concerned with a passive pre-charge system to improve braking performance in such systems.

Electronically controlled hydraulic brake systems for vehicles are well known. A typical system includes a master cylinder, fluid conduit arranged into a desired circuit, and wheel brakes. The master cylinder generates hydraulic forces in the circuit by pressurizing brake fluid when the driver steps on the brake pedal. The pressurized fluid travels through the fluid conduit in the circuit to actuate brake cylinders at the wheel brakes and slow the vehicle.

Electronically controlled hydraulic brake systems also include a hydraulic control unit (HCU) containing control valves and other components located between the master cylinder and the wheel brakes. Through an electronic controller, the control valves, a pump, and other components selectively control pressure to the wheel brakes to provide a desired braking response of the vehicle, including anti-lock braking, traction control, and vehicle stability control.

During anti-lock brake events, a driver is applying a brake pedal and thus pressurizing fluid via a master cylinder. This pressurized fluid is available for re-apply events that selectively permit pressurized fluid to reach the wheel brakes. A pump in the HCU draws fluid from the wheel brakes during a dump cycle and directs fluid to the wheel brakes during a re-apply cycle. Thus, pressurized fluid is available from both the master cylinder and the pump during a re-apply event.

During traction control and vehicle stability control events, a driver is usually not applying a brake pedal and thus the master cylinder does not provide pressurized fluid to the wheel brakes. Instead, the pump in the HCU is activated and provides a sole source of pressurized fluid available to the wheel brakes. A pump inlet can be placed in fluid communication with a fluid reservoir by selectively switching control valves mounted in the HCU.

Performance of the brake system can be adversely affected by various factors, including flow resistance at the inlet side of the pump. Primary sources of resistance on this suction side of the pump include the master cylinder, brake lines from the master cylinder to the HCU and from the HCU to the wheel brakes, and the HCU itself. In particular, the control valves, and other components, along with the various fluid passages formed in the HCU, create a significant restriction. Low temperature can also adversely affect the performance of the brake system. The viscosity of the brake fluid increases as the temperature decreases. High viscosity of the brake fluid at low temperature affects the ability of a pump to draw fluid. Low temperatures, combined with the above-discussed restrictions, can result in inadequate pump performance.

### BRIEF SUMMARY OF THE INVENTION

This invention relates to an electronically controlled vehicular hydraulic brake system that provides anti-lock braking, traction control, and/or vehicle stability control. The system includes a hydraulic control unit (HCU) containing control valves and other components in fluid communication with wheel brakes. A preferred system for improving braking performance according to the present invention includes a passive precharge system, including a precharge manifold, that provides improvements to Net Positive Suction Head available at the inlet of a pump during braking events in which the driver is not pressing on the brake pedal to supply brake fluid from the master cylinder. Performance of the braking system can be improved by the systems and methods according to this invention.

Various objects and advantages of this invention will become apparent to those skilled in the art from the following detailed description of the preferred embodiments, when read in light of the accompanying drawings.

### BRIEF DESCRIPTION OF THE DRAWINGS

FIG. 1 is a schematic circuit diagram of a vehicular brake system according to this invention.

FIG. 2 is a cross-sectional view of the precharge manifold of the system of FIG. 1.

### DETAILED DESCRIPTION OF THE PREFERRED EMBODIMENT

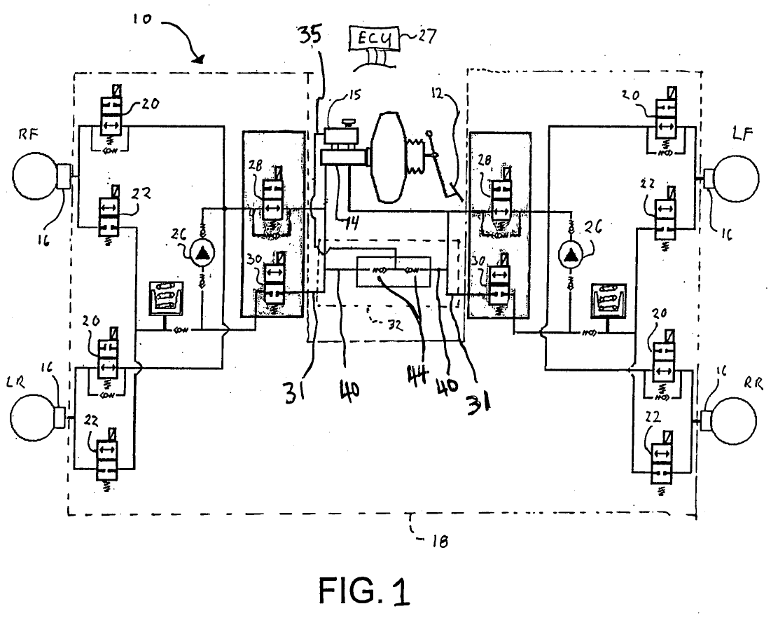

A vehicular brake system according to this invention is indicated generally at 10 in FIG. 1. The system 10 includes valves and other components described below to provide anti-lock braking (ABS), traction control (TC), and vehicle stability control (VSC) functions.

In the system 10, a brake pedal 12 is connected to a master cylinder 14 to provide pressurized brake fluid to wheel brakes 16. The master cylinder 14 is in fluid communication with a master cylinder brake fluid reservoir 15. The reservoir 15 is a source of bake fluid for the master cylinder 14.

A hydraulic control unit (HCU) 18 includes a housing having bores for receiving control valves and other components described below. Fluid passageways or conduits are provided between the bores to provide fluid communication between the valves and other components.

The HCU 18 includes normally open control valves 20, commonly referred to as isolation valves, and normally closed control valves 22, commonly known as dump valves, disposed between the master cylinder 14 and the wheel brakes 16. The pumps 26 are driven by an electric motor (not illustrated) in a well known manner.

Each isolation valve 20 is preferably formed as a solenoid valve switchable between two positions. Each dump valve 22 is preferably formed as a solenoid valve switchable between two positions. The valves 20 and 22 include a coil subassembly that creates an electromagnetic flux to slide an internal armature between the two positions. The valves 20 and 22, as well as pumps 26, are electrically connected to an electronic control unit 27 and operated to provide desired anti-lock braking in a well known manner.

The system 10 of FIG. 1 is illustrated as a diagonally split system, wherein the right front wheel RF and the left rear wheel LR are included in a circuit, and the left front wheel LF and the right rear wheel RR are included in a second circuit. Other configurations of the braking system 10 can be provided.

A TC/VSC isolation valve 28 is provided in each circuit. The TC/VSC isolation valves 28 are in fluid communication with the master cylinder 14 and the isolation valves 20.

A supply valve 30 is provided in each circuit. The supply valves 30 are in fluid communication with the master cylinder 14 and an inlet to the pump 26. When the brake pedal 12 is not actuated, and the pistons in the master cylinder 14 (not shown) are retracted, make-up ports are uncovered by the piston providing fluid communication between the master cylinder 14 and the primary and secondary brake circuit, in a well known manner. The supply valves 30 thus are connected to a first fluid conduit 31 providing fluid communication from the reservoir 15, through the master cylinder 14, to the suction (inlet) of the associated pump 26.

The valves 28 and 30 each include a coil subassembly that creates an electromagnetic flux to slide an internal armature between two positions. The valves 28 and 30 are electrically connected to the electronic control unit 27 and operated to provide desired anti-lock braking in a well-known manner.

The system 10 further includes a precharge manifold 32. The manifold 32 is in fluid communication with the master cylinder 14, the reservoir 15, the isolation valves 28, and the supply valves 30.

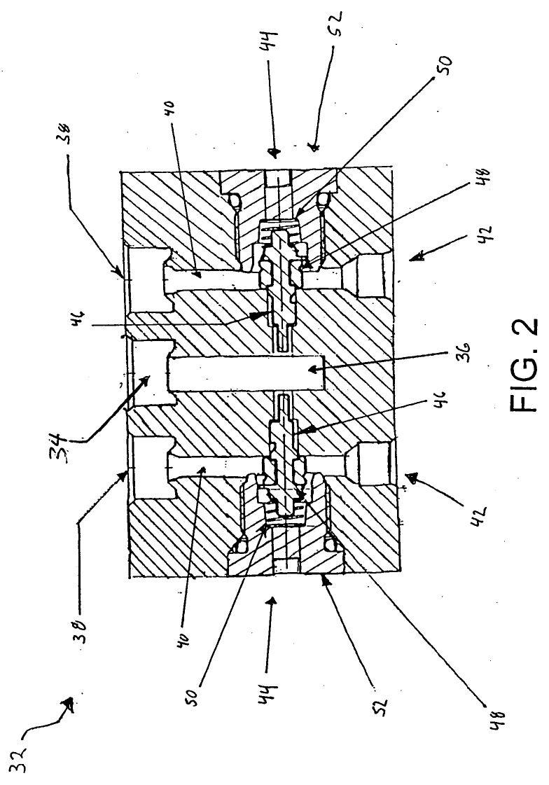

As best shown in FIG. 2 the precharge manifold 32 has a primary inlet port 34. The primary inlet port 34 is connected to the reservoir 15 by a hydraulic line 35, which connects to the reservoir below the normal fluid level of the reservoir 15, so that fluid can be drawn out of the reservoir 15 via the line 35. The primary inlet port is in fluid communication with an interior chamber 36.

The precharge manifold 32 includes a pair of master cylinder ports 38 in fluid communication with the master cylinder 14. Each of the master cylinder ports 38 is in fluid communication with a respective one of a pair of interior fluid passageways 40. The manifold 32 also includes a pair of valve ports 42, with each of the valve ports 42 being in fluid communication with a respective one of the interior fluid passageways 40. Each of the interior fluid passageways 42 is in fluid communication with respective ones of the pair of isolation valves 23 and with respective ones of the supply valves 30. Each of the interior fluid passageways 42 is thus in fluid communication with the associated first fluid conduit 31 providing fluid communication from the reservoir 15 via the master cylinder 14 to an associated pump 26.

The manifold 32 also includes a pair of check valves 44, which are preferably provided in the form of poppet valves, each of which, when open, allows fluid communication between the interior chamber 36 and a respective one of the interior passageways 40. As indicated above, the hydraulic line 35 provides fluid communication between the reservoir 15 and the interior chamber 36. When one of the check valves 44 is open, a second fluid conduit is opened up between the reservoir 14 and an associated one of the pumps 26.

The check valves 44 include respective poppet valve bodies 46, poppet valve seals 48 carried on an associated one of the poppet valve bodies, and poppet valve springs 50 urging an associated poppet body 46 and poppet valve seal 48 into engagement with the body of the precharge manifold 32 in a manner to prevent fluid communication between the associated interior fluid passageway 42 and the interior chamber 36. The check valves 44 are preferably secured in place by clinched end plugs 52.

During operation, when pressure in one of the interior passageways 40 is greater than in the interior chamber 38, the check valves 44 remains closed, preventing fluid communication between the interior passageways 40 and the interior chamber 38. However when pressure in one of the interior passageways 40 is less than in the interior chamber 38, the associated poppet valve(s) 44 open, providing fluid communication between the interior passageways 40 and the interior chamber 38.

During Vehicle Dynamic Control (VDC) events, such as Traction Control (TC), braking for Automated Cruise Control (ACC) or Collision Avoidance, or Vehicle Stability Control (VSC) events such as automatic selective braking of individual brakes to counter an adverse yaw or roll of the vehicle, the pumps 26 may be run to supply braking pressure when the driver is not stepping on the brake pedal 12 and thus not delivering hydraulic brake fluid under pressure from the master cylinder 14. When temperatures of the brake system are relatively low, and the viscosity of the hydraulic brake fluid is high, when the pumps 26 are running, there may be relatively large headloss between the master cylinder reservoir 15, via the master cylinder 14 to the supply valve 30, as this fluid path is typically a relatively small diameter line. This will be cause a relatively low pressure to be experienced in the associated internal fluid passageway 40. The interior chamber 30 is connected directly to the reservoir 15, preferably by a relatively large diameter fluid conduit, and thus will be at a relatively higher pressure than the internal fluid passageway 40 connected to the suction of a the pump 26 running under low temperature, high viscosity conditions. In this situation, according to the invention, the associated poppet valve 44 will open, providing an additional, relatively low headloss, fluid path from which the pump 26 can draw fluid, resulting in an increase in Net Positive Suction Head (NPSH) at the suction of the pump 26. The invention in thus directed to a passive system (not requiring electrical actuation of valves or pre-charge pumps) which increases the NPSH available to the pumps 26, thereby improving the performance of the pumps 26, particularly during VDC events such as TC and VSC events.

Optionally, a passive reservoir (not shown), for example with a rolling diaphragm, may be included in the system 10 located in the precharge line 35 upstream of the check valves 44. This would further eliminate line loss due to flow.

In addition, to further improve performance, a low wattage heater (not shown) may be included in the system 10. For example, the heater may be integrated into the reservoir 15.

The principle and mode of operation of this invention have been explained and illustrated in its preferred embodiment. However, it must be understood that this invention may be practiced otherwise than as specifically explained and illustrated without departing from its spirit or scope.

What is claimed is:

1. A vehicular braking system comprising:
a fluid supply reservoir containing hydraulic brake fluid;
a pump for supplying hydraulic brake fluid under pressure to a vehicle brake;
a first fluid conduit providing fluid communication from the reservoir to the pump;
a precharge manifold containing a check valve; and
a second fluid supply conduit providing fluid communication from the reservoir to the pump when said check valve is open.

2. The vehicular braking system according to claim 1, wherein said check valve is a poppet valve.

3. The vehicular braking system according to claim 1, wherein said precharge manifold is contained within a housing of a hydraulic control unit containing said pump.

4. The vehicular braking system according to claim 1, further including:
a hydraulic control unit housing containing said pump; and
a precharge housing containing said precharge manifold with said check valve.

5. The vehicular braking system according to claim 1, wherein said first fluid conduit is a primary brake circuit supplied by a master cylinder, the vehicle braking system further comprising:
a second pump for supplying hydraulic brake fluid under pressure to a second vehicle brake;
a third fluid conduit providing fluid communication from the reservoir to the second pump;
a second check valve disposed in said precharge manifold; and
a fourth fluid supply conduit providing fluid communication from the reservoir to the second pump when said second check valve is open.

6. The vehicle brake system according to claim 5 wherein said first check valve opens when pressure in said first fluid conduit is less than in said second fluid conduit, and said second check valve opens when pressure in said third fluid conduit is less than in said fourth fluid conduit.

7. The vehicle brake system according to claim 1 wherein said first check valve opens when pressure in said first fluid conduit is less than in said second fluid conduit
